(19) United States
(12) Patent Application Publication
(10) Pub. No.: US 2010/0000187 A1
(43) Pub. Date: Jan. 7, 2010

(54) ASSEMBLY OF CERAMIC FILTER AND METHOD OF ASSEMBLING THE SAME

(76) Inventor: Ki-ho Kim, Chungcheongnam-do (KR)

Correspondence Address: BERLINER & ASSOCIATES, 555 WEST FIFTH STREET, 31ST FLOOR, LOS ANGELES, CA, 90013, US

(21) Appl. No.: 12/521,896

(22) PCT Filed: Oct. 18, 2007
(86) PCT No.: PCT/KR07/05094

§ 371 Date: Jul. 1, 2009

(30) Foreign Application Priority Data
Jan. 3, 2007 (KR) 10-2007-0000444
Feb. 7, 2007 (KR) 10-2007-0012457

(51) Int. Cl. B01D 39/20; B23P 11/00; B01D 46/42

(52) U.S. Cl. 55/418; 29/428; 55/491

(57) ABSTRACT

The present invention relates to a ceramic filter assembly and an assembling method thereof, and particularly, to a ceramic filter assembly comprising a ceramic filter shaped like a tube whose lower part is closed, an upper shock absorber which has a shape corresponding to an upper section of the ceramic filter and is coupled with the upper section, an upper cap which has a coupling part accommodating the upper shock absorber and a part of the filter and a penetration part corresponds to the opening part of the ceramic filter, a lower shock absorber which has a shape corresponding to a lower section of the filter and is coupled with the lower section, a lower cap which has a coupling part accommodating the lower shock absorber and a part of the filter, and a connecting device which fixes the upper and lower caps vertically.

### FIELD OF THE INVENTION

Apparatuses and methods consistent with the present invention relate to a ceramic filter assembly and an assembling method thereof. More particularly, apparatuses and methods consistent with the present invention relate to a ceramic filter assembly and an assembling method thereof which is manufactured and assembled without difficulty to be used at high temperature and high pressure, lowers manufacturing costs, is reshaped easily, and is assembled into a large filter. Also, the ceramic filter assembly and the assembling method thereof enhances functionality and is for more general purposes, provides a maximum filtration area within a limited space of the filter with a high density assembly. Further, the ceramic filter assembly and the assembling method thereof is chemical-resistant, abrasive-resistant and heat-resistant, and efficiently adjusts a filtration area with a high density.

### BACKGROUND ART

Apparatuses and methods consistent with the present invention relate to a ceramic filter assembly and an assembling method thereof. More particularly, apparatuses and methods consistent with the present invention relate to a ceramic filter assembly and an assembling method thereof which lowers manufacturing costs, is assembled and reshaped without difficulty and assembled into a large filter, is chemical-resistant, abrasive-resistant and heat-resistant, and efficiently adjusts a filtration area with a high density.

A conventional ceramic filter includes a tube, and is generally manufactured by compression molding. Such a ceramic filter has relatively high filtration efficiency and good back pressure property. However, a mold is necessary to manufacture the conventional ceramic filter. Accordingly, the ceramic filter is hardly manufactured in large size. As the size of the ceramic filter is limited, a filtration area is small. Thus, it is very difficult to arrange the ceramic filter technically to be used. Even if the ceramic filter is manufactured with the mold, manufacturing costs are high and durability is lowered due to filter blinding, thereby lowering filtration efficiency.

Thus, it is required to develop a ceramic filter assembly and an assembling method thereof which is arranged technically and is assembled without difficulty.

### DISCLOSURE OF INVENTION

Accordingly, it is an aspect of the present invention to provide a large capacity ceramic filter assembly and an assembling method thereof which is chemical-resistant, abrasive-resistant and heat-resistant, has a relatively wide range of adjustment of a filtration area within a limited size.

Also, it is another aspect of the present invention to provide a ceramic filter assembly and an assembling method thereof which reduces manufacturing costs, is manufactured and reshaped easily, and is assembled into a large filter without difficulty.

Further, it is another aspect of the present invention to provide a ceramic filter assembly and an assembling method thereof which manufactures a high temperature filter to be replaced with an existing high molecular filter in a certain space, maximizes a filtration area by changing a shape and maximizes dust collection efficiency.

Additional aspects and advantages of the general inventive concept will be set forth in part in the description which follows and, in part, will be obvious from the description, or may be learned by practice of the general inventive concept.

The foregoing and/or other aspects and advantages of the present invention are achieved by providing a ceramic filter assembly, comprising a ceramic filter shaped like a tube whose upper part has an opening part and lower part is closed; an upper shock absorber which has a shape corresponding to an upper section of the ceramic filter and is coupled with the upper section; an upper cap which has a coupling part accommodating the upper shock absorber and a part of the ceramic filter and a penetration part corresponding to the opening part of the ceramic filter; a lower shock absorber which has a shape corresponding to a lower section of the ceramic filter and is coupled with the lower section; a lower cap which has a coupling part accommodating the lower shock absorber and a part of the ceramic filter; and a connecting device which fixes the upper and lower caps vertically.

The foregoing and/or other aspects and advantages of the present invention are achieved by providing an assembling method of a ceramic filter, comprising providing a ceramic filter shaped like a tube whose upper part has an opening part and lower part is closed; coupling an upper shock absorber having a shape corresponding to an upper section of the ceramic filter to an upper part of the ceramic filter and coupling an upper cap having a coupling part accommodating the upper shock absorber and a part of the ceramic filter and a penetration part corresponding to the opening part of the ceramic filter to the upper part of the ceramic filter; coupling a lower shock absorber having a shape corresponding to a lower section of the ceramic filter to a lower part of the ceramic filter and coupling a lower cap having a coupling part accommodating the lower shock absorber and a part of the ceramic filter, to the lower part of the ceramic filter; and fixing the upper and lower caps through a connecting device connecting the upper and lower caps vertically.

The ceramic filter assembly and the assembling method thereof according to the present invention lowers manufacturing costs, is manufactured and reshaped without difficulty and manufactures a large capacity filter within a limit of filter size. Upper and lower parts of the ceramic filter assembly are manufactured by different processes to reduce the manufacturing time of the assembly. As various types of ceramic filters with complex shapes are manufactured, they may maximize the filtration area within a certain space. That is, the ceramic filter assembly according to the present invention may provide at least five times filtration area of the existing filter, and may be reshaped according to purposes. Thus, the ceramic filter assembly is neither damaged nor lowered in performance at high temperature and high pressure. As the ceramic filter assembly is prevented from fire due to spark, it may be applicable to an incinerator, crematorium, boiler, cement manufacturing process, coal-fired power plant, IGCC, etc.

Even if the ceramic filter is damaged, only a damaged part is replaced to thereby reduce maintenance costs.

### BRIEF DESCRIPTION OF THE DRAWINGS

The above and/or other aspects of the present invention will become apparent and more readily appreciated from the following description of the embodiments, taken in conjunction with the accompanying drawings of which:

FIG. 1 is a schematic perspective view of a ceramic filter assembly according to an exemplary embodiment of the present invention;

FIG. 2 is an exploded perspective view of a ceramic filter assembly according to another exemplary embodiment of the present invention;

FIG. 3 shows a ceramic filter which is applicable to the ceramic filter assembly according to the present invention;

FIG. 4 shows upper and lower surfaces of an upper cap which applies to a ceramic filter assembly according to another exemplary embodiment of the present invention;

FIG. 5 shows upper and lower surfaces of a lower cap which applies to a ceramic filter assembly according to another exemplary embodiment of the present invention;

FIG. 6 shows the upper and lower caps which include a shock absorber therein in FIGS. 4 and 5;

FIG. 7 shows the shock absorber in FIG. 6;

FIG. 8 shows a connector of the ceramic filter assembly according to the exemplary embodiment of the present invention;

FIG. 9 shows an elastic member of the ceramic filter assembly according to the exemplary embodiment of the present invention;

FIG. 10 shows a ceramic filter assembly according to another exemplary embodiment of the present invention;

FIG. 11 shows various types of a ceramic filter assembly according to another exemplary embodiment of the present invention; and

FIGS. 12 to 15 show a metal member which is manufactured by an aluminum die casting and coated with teflon, of the ceramic filter assembly according to the exemplary embodiment of the present invention.

### MODES FOR CARRYING OUT THE INVENTION

Hereinafter, exemplary embodiments of the present invention will be described with reference to accompanying drawings, wherein like numerals refer to like elements and repetitive descriptions will be avoided as necessary.

A ceramic filter assembly according to the present invention includes a ceramic filter 10 shaped like a tube whose upper part is an opening part 12 and lower part is closed, an upper shock absorber 40 which has a shape corresponding to an upper section of the ceramic filter 10 and coupled with the upper section, an upper cap 20 which has a coupling part 22 accommodating the upper shock absorber 40 and a part of the upper part of the ceramic filter 10 and a penetration part 24 corresponding to the opening part 12 of the ceramic filter 10, a lower shock absorber 40 which has a shape corresponding to a lower section of the ceramic filter 10 and is coupled with the lower section, a lower cap 30 which has a coupling part 32 accommodating the lower shock absorber 40 and a part of the lower part of the ceramic filter 10, and a connecting device 50 which vertically connects the upper cap 20 and the lower cap 30.

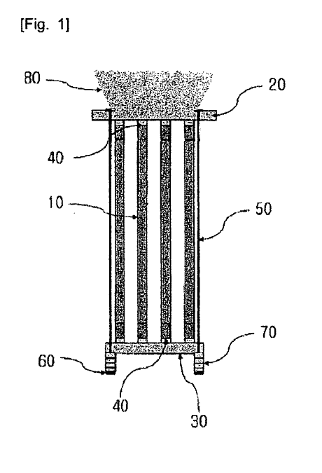

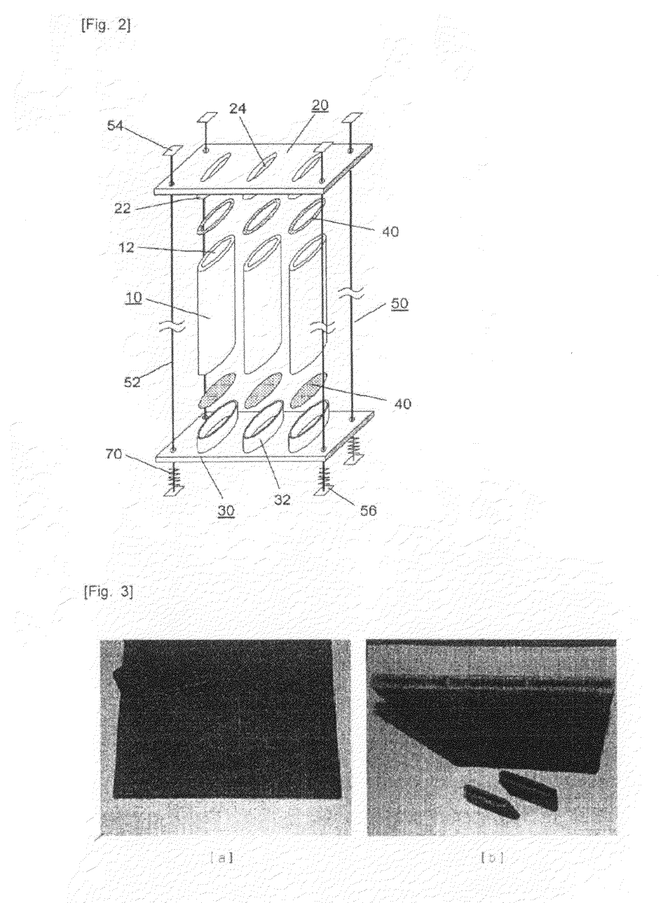

As shown in FIGS. 1 and 2, the ceramic filter assembly according to the present invention includes a plurality of small-sized ceramic filters 10 to be assembled into a large ceramic filter having better performance than an integrated ceramic filter. The ceramic filter assembly according to the present invention includes the upper cap 20 and the lower cap 30 to fix the ceramic filter 10, and the connecting device 50 to connect the upper and lower caps 20 and 30. As the ceramic filter 10 is highly brittle, the shock absorber 40 is provided in a coupling surface of the upper and lower caps 20 and 30 not to be damaged.

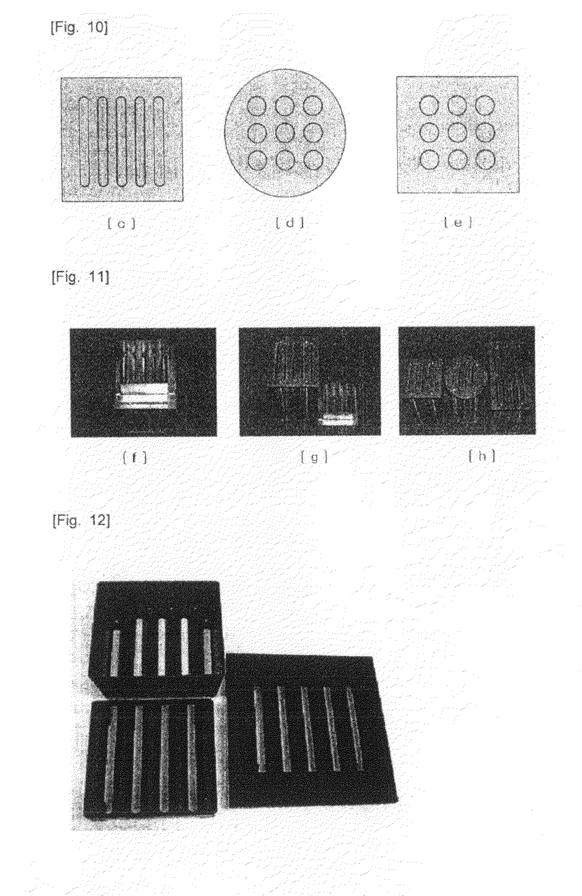

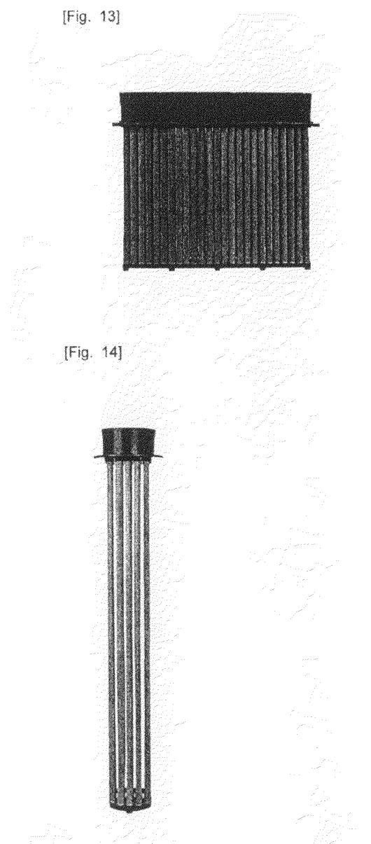

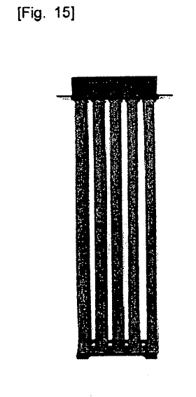

The ceramic filter 10 includes ceramic filters manufactured by various known arts. The ceramic filter 10 includes a carrier having slurry developed by the present inventor as well as includes a conventional compressed molding. FIG. 3 illustrates the ceramic filter 10 according to the exemplary embodiment of the present invention. The ceramic filter 10 may be cylindrical as shown in (d) and (e) in FIG. 10 as well as those in FIGS. 2 and 3. Alternatively, the ceramic filter 10 may include rectangular and radial containers. The ceramic filter 10 may vary as long as it has an opening part as an inlet (or an outlet) of a filtered object and filters the filtered object through a filter medium as a main body. Here, inlet and outlet directions of the filtered object are determined by a flowing direction of the object. Generally, in the ceramic filter 10, air flows vertically, is sucked to a surface of the filter medium to be discharged by the opening part. Thus, the ceramic filter 10 includes the opening part 12 as the outlet of the filtered object.

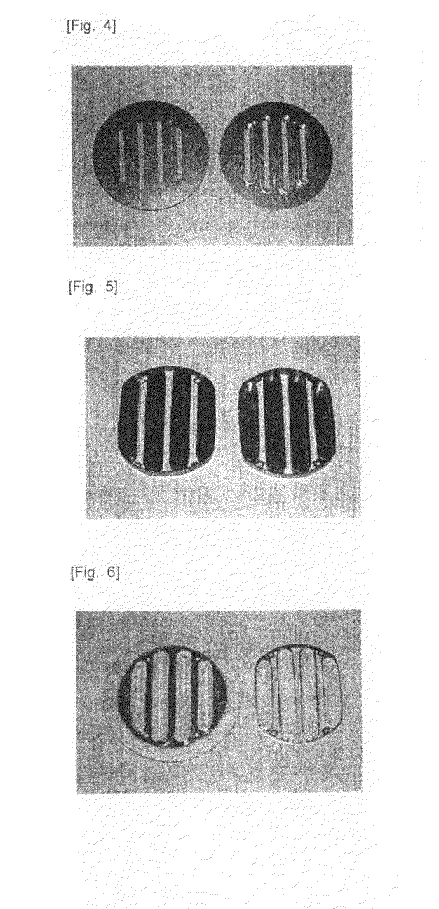

At least one or two and above, and preferably a plurality of ceramic filters 10 may be assembled into a single assembly. As shown in FIG. 2, three ceramic filters 10 are assembled into a single assembly. The ceramic filters 10 are connected by the upper and lower caps 20 and 30 which have the connectors 22 and 32 to connect opposite ends of the ceramic filters 10. That is, as shown in FIGS. 2, 4 and 5, the upper and lower caps 20 and 30 include the coupling parts 22 and 32 so that a groove corresponding to an end part of the ceramic filters 10 is coupled with the coupling parts 22 and 32 of the ceramic filters 10. The shape of the coupling parts 22 and 32 is not limited to those in FIG. 2. Alternatively, the coupling parts 22 and 32 may vary as long as they tightly fix the end part of the ceramic filters 10. The upper cap 20 includes the penetration part 24 corresponding to the opening part 12 of the ceramic filter 10 so that a filtered object is sucked to the ceramic filter 10.

The upper and lower caps 20 and 30 may include various known materials, and preferably plastic or metal. For example, stainless steel may be plated or welded. Preferably, the upper and lower caps 20 and 30 include metal (e.g. stainless steel) to be, heat-resistant and corrosion-resistant. The metal may be coated with teflon to form a teflon-coating layer on the surface of the upper and lower caps 20 and 30 to thereby enhance chemical resistance.

More preferably, the upper and lower caps 20 and 30 are manufactured by an aluminum die casting, casting or press to have an accurate size and to be manufactured without difficulty. The aluminum die casting is most preferable. The upper and lower caps 20 and 30 which are manufactured by the aluminum die casting are coated with teflon to form a teflon-coating layer on the surface of the upper and lower caps 20 and 30 to thereby enhance chemical resistance.

FIGS. 10 and 11 illustrate a combination of various ceramic filters 10 and caps 20 and 30.

The shock absorber 40 is inserted between the ceramic filter 10 and the upper and lower caps 20 and 30 to tightly connect the ceramic filter 10 and the caps 20 and 30, and to prevent the ceramic filter 10 from being damaged. The shock absorber 40 corresponds to opposite ends of the ceramic filter 10 as shown in FIG. 7. As shown in FIG. 6, the shock absorber 40 is inserted into the coupling parts 22 and 32 of the upper and lower caps 20 and 30.

The shock absorber 40 may include various shock-absorbing materials. Preferably, the shock absorber 40 includes at least one of silicon, rubber, nonwoven fabric, a ceramic pad and a mica pad to secure heat resistance and corrosion resistance.

After the shock absorber 40 is inserted between the upper and lower caps 20 and 30, the connecting device 50 is connected with the upper and lower caps 20 and 30 to fix them vertically.

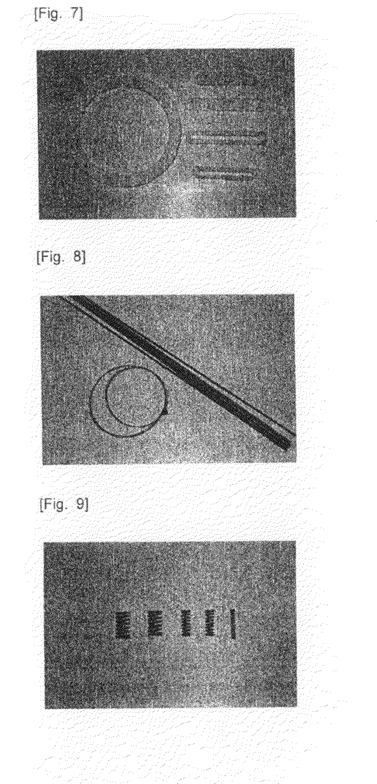

The connecting device 50 may include various known connectors to connect two components with each other. Preferably, the connecting device 50 includes a connector 52 which is shaped like a rope or a bar (metal or plastic material) to pass through the upper and lower caps 20 and 30, an upper fixing part 54 which is connected with an end part of the connector 52 protruding from the upper cap 20 and a lower fixing part 56 which is connected with an end part of the connector 52 protruding from the lower cap 30. FIGS. 2 and 8 illustrate the connecting device 50 according to the exemplary embodiment of the present invention. The upper and lower fixing parts 54 and 56 may be called a fixing device 60.

The fixing parts 54 and 56 may be coupled to fix the upper and lower caps 20 and 30 through a coupling means such as a bolt, a nut, or a turn buckle. If the connecting device 50 includes metal, the fixing parts 54 and 56 further include a teflon-coating layer on a surface thereof to secure corrosion resistance and chemical resistance.

The connecting device 50 may be provided in an external side as shown in FIG. 2. Alternatively, a part of or the overall connecting device 50 is provided between the ceramic filters 10 to minimize an interference with other components.

As the ceramic filter assembly according to the present invention is mainly used at high temperatures, heat expansion may occur when used. In this case, the connecting device 50 may further include an elastic member including a metal spring between the upper surface of the upper cap 20 and the upper fixing part 54 or between the lower part of the lower cap 30 and the lower fixing part 56 to absorb a deformation of the components due to the heat expansion. FIG. 2 illustrates the metal spring provided between the lower part of the lower cap 30 and the lower fixing part 56 as an example. An example of the elastic member is as shown in FIG. 9.

If the elastic member includes metal, its surface is coated with teflon to form a teflon-coating layer on a surface thereof to thereby enhance chemical resistance.

To raise filtration efficiency, the upper cap 20 of the ceramic filter assembly according to the present invention may further include a venturi 80 which includes the penetration part 24 therein, is coupled with the upper part of the upper cap 20 and includes a plastic or metal material tapered off to the upper cap 20. (f) in FIG. 11 illustrates the upper cap 20 including the venturi 80 while (g) in FIG. 11 illustrates the upper cap 20 separated with the venturi 80. If the venturi 80 includes a metal material, its surface is coated with teflon to form a teflon-coating layer thereon to thereby enhance chemical resistance, etc.

The ceramic filter assembly according to the present invention may be applicable to an incinerator, or a filter medium of cement, iron steel, boiler, dust collecting device of a smelting furnace, dust collecting device of engine exhaust and auto exhaust, or a removing device of VOCs (volatile organic compounds), IGCC system (integrated coal gasfication combined cycle system), etc.

The assembling method of the ceramic filter assembly according to the present invention includes providing a ceramic filter 10 having a tube whose upper part is the opening part 12 and the lower part is closed, coupling the upper shock absorber 40 corresponding to the upper section of the ceramic filter 10 to the upper part of the ceramic filter 10 and coupling the upper cap 20 having the coupling part 22 accommodating the upper shock absorber 40 and the part of the ceramic filter 10 and the penetration part 24 corresponding to the opening part 12 of the ceramic filter 10, to the upper part of the ceramic filter 10, coupling the lower shock absorber 40 corresponding to the lower section of the ceramic filter 10 to the lower part of the ceramic filter 10 and coupling the lower cap having the coupling part 32 accommodating the lower shock absorber 40 and the part of the ceramic filter 10, to the lower part of the ceramic filter 10 and fixing the upper and lower caps 20 and 30 through the connecting device 50 connecting the upper and lower caps 20 and 30 vertically. The detailed description is as provided above.

Preferably, the connecting device 50 includes the connector 52 which is shaped like a rope or a bar to pass through the upper and lower caps 20 and 30, the upper fixing part 54 which is connected with the end part of the connector 52 protruding from the upper cap 20 and the lower fixing part 56 which is connected with the end part of the connector 52 protruding from the lower cap 30. The elastic member including the metal spring is provided between the upper surface of the upper cap 20 and the upper fixing part 54 or between the lower part of the lower cap 30 and the lower fixing part 56, to fix the upper and lower caps 20 and 30.

As described above, the present invention provides a ceramic filter assembly and an assembling method thereof which lowers manufacturing costs, is manufactured and reshaped without difficulty and manufactures a large capacity filter within a limit of filter size. Upper and lower parts of the ceramic filter assembly are manufactured by different processes to reduce the manufacturing time of the assembly. As various types of ceramic filters are manufactured, they may maximize the filtration area within a certain space. That is, the ceramic filter assembly according to the present invention may provide at least five times filtration area of the existing filter, and may be reshaped according to purposes. Thus, the ceramic filter assembly is neither damaged nor lowered in performance at high temperature and high pressure. As the ceramic filter assembly is prevented from fire due to spark, it may be applicable to an incinerator, crematorium, boiler, cement manufacturing process, coal-fired power plant, IGCC, etc.

Even if the ceramic filter is damaged, only a damaged part is replaced to thereby reduce maintenance costs.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A ceramic filter assembly, comprising:
a ceramic filter shaped like a tube whose upper part has an opening part and lower part is closed;
an upper shock absorber which has a shape corresponding to an upper section of the ceramic filter and is coupled with the upper section;
an upper cap which has a coupling part accommodating the upper shock absorber and a part of the ceramic filter and a penetration part corresponding to the opening part of the ceramic filter;
a lower shock absorber which has a shape corresponding to a lower section of the ceramic filter and is coupled with the lower section;
a lower cap which has a coupling part accommodating the lower shock absorber and a part of the ceramic filter; and
a connecting device which fixes the upper and lower caps vertically.

2. The ceramic filter assembly according to claim 1, wherein the upper and lower caps comprise plastic or metal,
the shock absorber comprises at least one of silicon, rubber, nonwoven fabric, a ceramic pad and a mica pad, and
the connecting device comprises a connector which is shaped like a rope or a bar to pass through the upper and lower caps, an upper fixing part which is connected with an end part of the connector protruding from the upper cap and a lower fixing part which is connected with an end part of the connector protruding from the lower cap.

3. The ceramic filter assembly according to claim 1, wherein the upper and lower caps are manufactured by an aluminum die casting.

4. The ceramic filter assembly according to claim 2, wherein the connecting device further comprises an elastic member which has a metal spring between an upper surface of the upper cap and the upper fixing part or between a lower part of the lower cap and the lower fixing part.

5. The ceramic filter assembly according to claim 1, wherein the upper cap further comprises a venturi which has a penetration part therein, is coupled with the upper part of the upper cap, is tapered off to the upper cap and comprises a plastic or metal material.

6. The ceramic filter assembly according to one of claims 1 to 5, wherein at least one of the upper cap, the lower cap, the connecting device and the elastic member comprises a metal material and has a teflon-coating layer on a surface thereof.

7. An assembling method of a ceramic filter, comprising:
providing a ceramic filter shaped like a tube whose upper part has an opening part and lower part is closed;
coupling an upper shock absorber having a shape corresponding to an upper section of the ceramic filter, to an upper part of the ceramic filter, and coupling an upper cap having a coupling part accommodating the upper shock absorber and a part of the ceramic filter and a penetration part corresponding to the opening part of the ceramic filter, to the upper part of the ceramic filter;
coupling a lower shock absorber having a shape corresponding to a lower section of the ceramic filter to a lower part of the ceramic filter and coupling a lower cap having a coupling part accommodating the lower shock absorber and a part of the ceramic filter, to the lower part of the ceramic filter; and
fixing the upper and lower caps through a connecting device connecting the upper and lower caps vertically.

8. The assembling method according to claim 7, wherein the connecting device comprises a connector which is shaped like a rope or a bar to pass through the upper and lower caps, an upper fixing part which is connected with an end part of the connector protruding from the upper cap and a lower fixing part which is connected with an end part of the connector protruding from the lower cap, and
the fixing the upper and lower caps comprises coupling an elastic member having a metal spring between the upper surface of the upper cap and the upper fixing part or between the lower part of the lower cap and the lower fixing part to fix the upper and lower caps.
